(19) United States
(12) Patent Application Publication
(10) Pub. No.: US 2022/0213906 A1
(43) Pub. Date: Jul. 7, 2022

(54) HYDRAULIC ACTUATOR

(71) Applicant: J.C. BAMFORD EXCAVATORS LIMITED, Uttoxeter (GB)

(72) Inventors: Ravinder Padam, Ludhiana (IN); Roopak Sharma, Faridabad (IN); Sanjeev Arora, Faridabad (IN)

(73) Assignee: J.C. BAMFORD EXCAVATORS LIMITED, Uttoxeter (GB)

(21) Appl. No.: 17/522,862

(22) Filed: Nov. 9, 2021

(30) Foreign Application Priority Data
Nov. 9, 2020 (IN) 202011048915

(51) Int. Cl. F15B 15/14; F15B 15/22; F16F 9/19; F16F 9/32

(52) U.S. Cl. CPC F15B 15/1423; F15B 15/228; F16F 9/483; F16F 9/3214; F16F 9/19

(57) ABSTRACT

A hydraulic actuator includes a body defining a bore having a first end surface, a second end surface, and a bore surface, and a piston slidable in the bore. The piston, bore surface and first end surface define a first chamber, and the piston, bore surface and second end surface define a second chamber. The body also defines an accumulator chamber and a fluid passage between the first chamber and the accumulator chamber. An accumulator is received in the accumulator chamber and a valve selectably opens and closes the fluid passage.

### FIELD

This invention relates to a hydraulic actuator. The invention also relates to a material handling machine having a hydraulic actuator.

### BACKGROUND

Some material handling machines are required to perform two distinct tasks, firstly a loading task where material is moved relatively short distances and loaded into hoppers, trucks or the like. Secondly, in a transport mode a material handling machine is required to transport a single load a significant distance, often over undulating terrain. Driving over undulating terrain can be uncomfortable for an operator.

### SUMMARY

An object of the present invention is to provide a compact hydraulic actuator.

An object of the present invention is to provide an improved material handling machine.

Thus, according to an aspect of the present invention there is provided a hydraulic actuator having a body defining a bore, the bore having a first end surface, a second end surface and a bore surface, a piston slidable in the bore, the piston, bore surface and first end surface defining a first chamber, the piston, bore surface and second end surface defining a second chamber, a piston rod, connected to the piston, the body further defining an accumulator chamber and a fluid passage between the first chamber and the accumulator chamber, the hydraulic actuator further including an accumulator received in the accumulator chamber and a valve for selectably opening and closing the fluid passage.

According to an aspect of the present invention there is provided a material handling machine having a material handling implement configured to move relative to a body of the material handling machine by operation of a hydraulic actuator, the material handling machine having a first mode of operation wherein the valve is closed and having a second mode of operation wherein the valve is open.

### BRIEF DESCRIPTION OF THE DRAWINGS

The invention will now be described by way of example only, with reference to the accompanying drawings in which:

FIG. 1 is a view of a material handling machine according to the present invention including a hydraulic actuator according to the present invention;

FIG. 2 is a cross-section view of a hydraulic actuator according to the present invention; and

FIG. 3 is an enlarged view of part of FIG. 2.

### DETAILED DESCRIPTION OF THE EMBODIMENTS

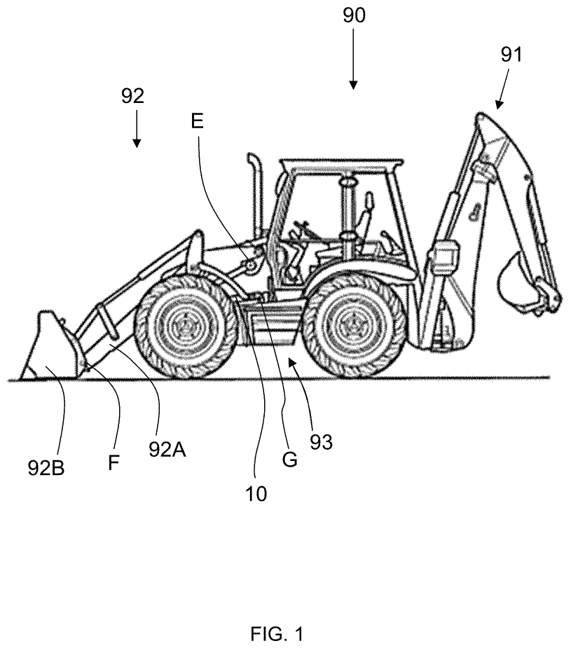

FIG. 1 shows a material handling machine, in this case a backhoe loader 90 having a backhoe 91 and a loader 92.

The loader 92 includes a loader arm 92A pivotable about axis E relative to a body or chassis 93 of the back hoe loader. A material handling implement, in this embodiment a loader shovel 92B, is pivotable about axis F relative to the loader arm 92A. Pivotable movement of the loader arm 92A about axis E is controlled by two hydraulic actuators 10, one mounted on each side of the vehicle and accordingly only one which is visible in FIG. 1. Attachment and operation of the two hydraulic actuator 10 is identical and accordingly only operation of the hydraulic actuator 10 visible in FIG. 1 will be described.

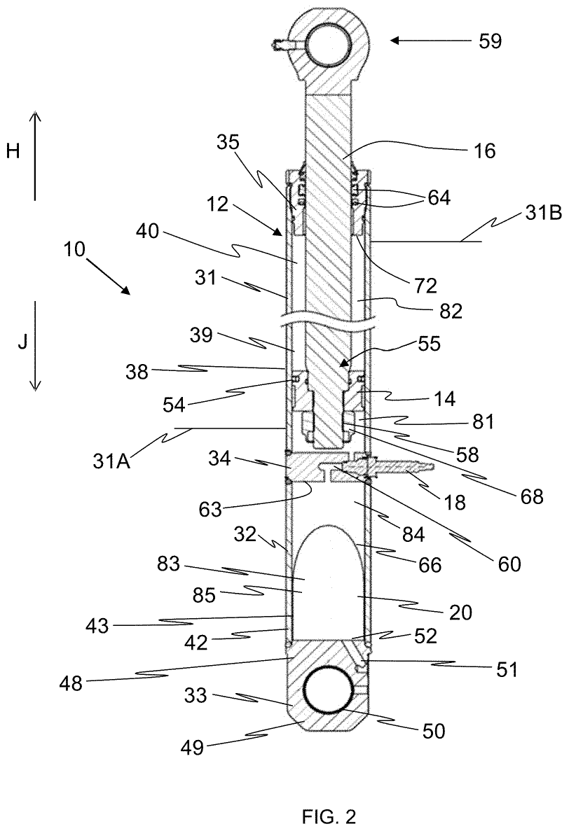

The hydraulic actuator 10 shown in FIG. 1 is pivotally attached to the chassis about axis G via a pivot pin which passes through hole 50 of attachment portion 49 (see FIG. 2 and description below). The rod eye 59 is pivotally attached to the loader arm 92A via a pivot pin passing through the rod eye. As will be appreciate, the rod eye 59 of the hydraulic actuator 10 as shown in FIG. 1 is obscured by the front left wheel of the back hoe loader.

Extension of the hydraulic actuator 10 causes the loader arm 92A to pivot in a clockwise direction about pivot E when viewing FIG. 1, thereby raising the loader shovel 92B and any load contained therein. Retraction of the hydraulic actuator 10 causes the loader arm 92A to pivot in an anti-clockwise direction about axis E, thereby lowering the loader shovel 92B and any load contained therein.

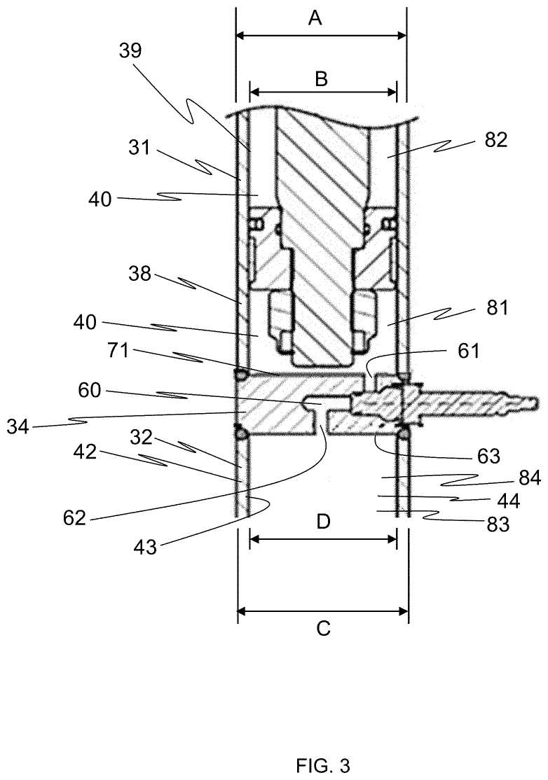

With reference to FIGS. 2 and 3, there is shown the hydraulic actuator 10 having a body 12, a piston 14, a piston rod 16, a rod seal arrangement 25, a valve 18 and an accumulator 20.

The body 12 includes a first tube 31, a second tube 32, an end cap 33, and a partition wall 34.

The first tube 31 is cylindrical and defines a bore wall 38 having an outer diameter A and an inner diameter B. The inner diameter B defines a bore surface 39 of a bore 40 of the first tube 31.

The first tube 31 includes ports 31A and 31B (both shown schematically only on FIG. 2).

The second tube 32 is cylindrical and defines an accumulator chamber wall 42 having an outer diameter C and an inner diameter D. The inner diameter defines a bore surface 43 of a bore 44 of the second tube 32.

The end cap 33 includes a cylindrical portion 48 and an attachment portion 49 having a hole 50. The end cap 33 also defines a passage 51.

The piston is circular and includes a piston seal 54. The piston includes a central hole 55.

The piston rod is generally elongate and includes a threaded portion 58 at one end and a rod eye 59 at an opposite end.

The partition wall 34 is generally circular and includes a passage 60 having a first end 61 and a second end 62.

The rod seal arrangement 35 is generally cylindrical and includes rod seals 64.

The accumulator 20 includes a flexible membrane 66.

The body 12 is assembled as follows:—

The accumulator is assembled into the second tube 32 and the end cap 33 is then attached to the second tube 32 (e.g. by welding, screw fitting or the like). The partition wall is attached to an opposite end of the second tube 32 (e.g. by welding, screw fitting or the like). The first tube is attached to the partition wall 34 (e.g. by welding, screw fitting or the like). Note that alternative orders of assembly are possible.

The actuator 10 is assembled as follows:

The valve 18 is assembled onto the partition wall 34 (e.g. by welding, screw fitting or the like) of the body 12.

The rod seals 64 are assembled into the rod seal arrangement 35 and the rod seal arrangement 35 is slid onto the piston rod 16. The piston is slid onto the rod and tightened in place by nut 68 engaging threaded portion 58. The piston seals 54 are assembled onto the piston 14. Note that alternative orders of assembly are possible.

The piston 14 is slid into the bore 40 and the rod seal arrangement 35 is attached to the end of the first tube 31, e.g. by screw fitting.

As assembled, it can be seen that the bore 40 has a first end surface 71 defined by the surface of the partition wall 34 facing the piston 14. The bore 40 also has a second end surface 72 defined by a surface of the rod seal arrangement facing the piston 14.

The piston 14 is slidable within the bore 40 as will be further described below.

The piston 14, bore 40 and first end surface 71 define a first chamber 81. The piston 14, bore 40 and second end surface 72 define a second chamber 82.

An accumulator chamber 83 is defined by the bore surface 43, a surface 52 of the end cap 33 facing the partition wall 34 and a surface 63 of the partition wall facing the end cap 33.

The flexible membrane 66 of the accumulator 20 divides the accumulator chamber 83 into a first portion 84 proximate to the partition wall 34 and a second portion 85 proximate the end cap 33.

Once assembled, the first chamber 81, second chamber 82 and first portion 84 are primed with hydraulic fluid via ports 31A and 31B and/or via further fill and bleed ports (not shown). The second portion 85 is filled with a pressurized gas via passage 51 which acts as an accumulator charging port.

Operation of the actuator 10 is as follows.

One task frequently performed by a back hoe loader is that of “loading” whereby the loader shovel is used to move material a relatively short distance, e.g. to pick up loose material from the ground and load it into an adjacent truck. Under these circumstances, the operator is almost constantly raising or lowering the loader arm, e.g. raising the loader arm to pick up the load and raise it to a height where it can be loaded into the truck, and once dumped in the truck, then immediately lowering the arms in order to prepare for picking the next load. Under these circumstances, a loading cycle might take in the order of 30 seconds. Under these circumstances, valve 18 will be closed, as will be further explained below. For the purposes of explanation, this mode will be described hereafter as a loader mode.

An alternative mode of operation is that of transporting a single load from one site to another site. Under these circumstances, once the load has been picked up by the loader shovel, then the loader arm will remain at a mid-height and the operator will then drive the back hoe loader from the first site to the second site. Travelling from the first site to the second site may take several minutes or even hours. Under these circumstances, valve 18 will be open as further described below. For the purposes of explanation, this mode will hereafter be described as a transport mode.

### Operation in the Loader Mode

When operating in the loader mode as mentioned above, the valve 18 will be closed. Under these circumstances, the first end 61 of passage 60 is fluidly isolated from the second end 62 by virtue of the valve 18 being closed. Under these circumstances, in order to lift the loader arm, pressurized hydraulic fluid is supplied to the first chamber 81 via the port 31A which causes the piston 14 and hence piston rod 16 to move in the direction of arrow H of FIG. 2. Consequently, hydraulic fluid in the second chamber 82 is allowed to be vented via port 31B. As will be appreciated, this causes the hydraulic actuator to extend.

In order to lower the loader arm, hydraulic fluid from the first chamber 81 is vented via port 31A (and consequently hydraulic fluid is allowed to enter the second chamber 82 via port 31B) thereby causing the piston rod to move in the direction of arrow J of FIG. 2, i.e. causing the hydraulic actuator 10 to retract.

### Transport Mode

As mentioned above, when in the transport mode, valve 18 is open. With valve 18 open, first end 61 of passage 60 is fluidly connected to second end 62 and consequentially first chamber 81 is fluidly connected to the first portion 84 of the accumulator chamber 83. Accordingly, hydraulic pressure in the first chamber 81 will be at the same nominal pressure as in the first portion 84 of the accumulator chamber 83.

Since the first portion 84 of the accumulator chamber 83 is separated by the flexible membrane 66 from the second portion 85, then consequently the hydraulic pressure in the first portion 84 will be the same as the gas pressure in the second portion 85.

Thus consider the scenario where the back hoe loader 90 is in the transport mode and is carrying a load in the loader shovel along an uneven road. As the back hoe loader hits a bump in the road, the inertia of the load in the loader shovel will cause the pressure in the first chamber 81 to increase which in turn will increase the pressure in the first portion 84 of the accumulator chamber. This will cause the flexible membrane 66 to move to the left when viewing FIG. 2 resulting in the gas in the second portion 84 being compressed in order to match the instantaneous pressure in the first portion 84 and first chamber 81. This moving of flexible membrane 66 to the left allows the hydraulic actuator 10 to momentarily retract as the back hoe loader goes over the bump thereby allowing the loader arm 92A to pivot slightly relative to the chassis 93. As will be appreciated, with the valve 18 open the loader arm 92A is resiliently mounted relative to the chassis and this resilient mounting improves the ride of the back hoe loader which therefore improves the comfort for the operator.

The particular construction of the hydraulic actuator 10 has several advantages.

The accumulator is integrated into the body of the hydraulic actuator thereby providing for a compact arrangement.

The passage 60 is relatively short (being little more than the thickness of the partition wall 34). With a short passage 60, variations in pressure in the first chamber 81 are quickly seen as variations in pressure in the first portion 84. As such, the accumulator is capable of responding quickly to any variations in pressure in first chamber 81 caused by the vehicle hitting bumps/undulations and the like and this provides for an improved ride and hence comfort for the operator.

The physical positioning of the first chamber 81, second chamber 82 and accumulator chamber 83, in alignment between the attachment portion 49 and rod eye 59, mean that axial loads seen in the bore wall 38 and accumulator chamber wall 42 can all be efficiently transmitted to the attachment portion 49. Thus, the second tube 32 which partially defines the accumulator chamber is concentric with the first tube 31 which partially defines the first and second chambers. Furthermore, the outer diameter A of the first tube 31 is the same as the outer diameter C of the second tube 32. Furthermore, the inner diameter B of the first tube is the same as the inner diameter D of the second tube. Accordingly, axial loads in one tube are efficiently transmitted to axial loads in the other tube via the partition wall 34.

In further embodiments, whilst the inner and/or outer diameters of the first and second tubes may not be the same, it is advantageous to have a diameter of one of the tubes overlap a diameter of the other of the tubes, for example, it is advantageous to have an inner diameter of one of the tubes be greater than an inner diameter of the other tube but less than an outer diameter of the other tube. Alternatively, it is advantageous for an outer diameter of one of the tubes to be less than the outer diameter of the other of the tubes but more than the inner diameter of the other of the tubes.

In alternative embodiments the body may not be cylindrical and/or the accumulator chamber may not be cylindrical, for example they may have an oval or other non-circular cross-section. Similarly, the partition wall may be non-circular.

The actuator may be double or single acting.

The valve 18 may be operated in any manner, but advantageously the valve may be a solenoid operated valve.

As shown in FIG. 2, the accumulator 20 includes a flexible membrane or diaphragm and is gas pressurized. However, any type of accumulator may be used, including an accumulator having a piston slidable within a bore and/or an accumulator having a bias device, such as a spring to react against pressure within the first portion 84.

The material handling machine shown in FIG. 1 is a backhoe loader, but the hydraulic actuator can be used on any other suitable type of material handling machine, for example a loading shovel, a telehandler or the like.

1. A hydraulic actuator comprising a body defining a bore, the bore having a first end surface, a second end surface, and a bore surface,
a piston slidable in the bore,
the piston, bore surface and first end surface defining a first chamber,
the piston, bore surface and second end surface defining a second chamber,
a piston rod, connected to the piston,
the body further defining an accumulator chamber and a fluid passage between the first chamber and the accumulator chamber,
the hydraulic actuator further including
an accumulator received in the accumulator chamber and a valve for selectably opening and closing the fluid passage.

2. The hydraulic actuator as defined in claim 1 wherein the body is generally cylindrical.

3. The hydraulic actuator as defined in claim 1 wherein the accumulator chamber is cylindrical.

4. The hydraulic actuator as defined in claim 3 wherein the accumulator chamber is concentric with the bore.

5. The hydraulic actuator as defined in claim 1 wherein the body defines a bore wall of the bore and the accumulator chamber defines an accumulator chamber wall, wherein a diameter of the bore wall overlaps a diameter of the accumulator chamber wall.

6. The hydraulic actuator as defined in claim 5 wherein an inner diameter of the bore wall is the same as an inner diameter of the accumulator chamber wall.

7. The hydraulic actuator as defined in claim 5 wherein an outer diameter of the bore wall is the same as an outer diameter of the accumulator chamber wall.

8. The hydraulic actuator as defined in claim 1 further including a partition wall positioned between the first chamber and the accumulator chamber.

9. The hydraulic actuator as defined in claim 8 wherein the partition wall defines the first end surface.

10. The hydraulic actuator as defined in claim 8 wherein the partition wall defines the fluid passage.

11. The hydraulic actuator as defined in claim 8 wherein the valve is mounted on the partition wall.

12. The hydraulic actuator as defined in claim 8 wherein the partition wall is circular.

13. The hydraulic actuator as defined in claim 1 wherein the valve is a solenoid operated valve.

14. The hydraulic actuator as defined in claim 1 wherein the accumulator includes a flexible diaphragm or wherein the accumulator includes an accumulator piston slidable in the accumulator chamber.

15. The hydraulic actuator as defined in claim 1 wherein the hydraulic actuator is a double acting hydraulic actuator.

16. The hydraulic actuator as defined in claim 1 wherein the hydraulic actuator is a single acting hydraulic actuator.

17. The hydraulic actuator as defined in claim 1 wherein the piston rod extends through the second end surface.

18. A material handling machine having a material handling implement configured to move relative to a body of the material handling machine by operation of a hydraulic actuator as defined in claim 1, the material handling machine having a first mode of operation wherein the valve is closed and having a second mode of operation wherein the valve is open.
